(19) United States
(12) Patent Application Publication
(10) Pub. No.: US 2002/0025385 A1
(43) Pub. Date: Feb. 28, 2002

(54) FIXATION PROCESS FOR CHEMICALLY TREATED WOOD

(76) Inventor: TONY BERGERVOET, AUCKLAND (NZ)

Correspondence Address: SUGHRUE MION ZINN MACPEAK & SEAS, 2100 PENNSYLVANIA AVENUE NW, WASHINGTON, DC, 200373202

(21) Appl. No.: 09/254,225

(22) PCT Filed: Sep. 4, 1997
(86) PCT No.: PCT/AU97/00575

(30) Foreign Application Priority Data
Sep. 4, 1996 (AU) PO-2133

(51) Int. Cl. B05D 1/18; B05D 7/06

(52) U.S. Cl. 427/440

(57) ABSTRACT

A fixation process for chemically treated wood which comprises transferring wood which has been treated with one or more chemical protectants into a fixation vessel; applying a treatment volume of water to the wood in batches or a continuous stream, collecting the water after application to the wood so that it can be used to prepare protectant impregnation solution and removing the wood from the fixation vessel.

### FIELD OF THE INVENTION

The present invention relates to a fixation process for chemically treated wood. It should be born in mind however, that as used throughout this specification and the appended claims the term “fixation” is intended to include within its scope actual fixation where chemicals impregnated within the wood are bound to wood components to form compounds of reduced water solubility, as well as the processes of washing and draining of wood which has been treated with other chemicals, such as fire retardants, insecticides etc, so that as a result of the process leaching of excess chemical from the wood will be minimised. An important aspect of the present invention, although by no means the exclusive focus, is the fixation of wood which has been treated with one or more heat fixing chemical protectants.

### BACKGROUND OF THE INVENTION

The treatment of wood by impregnation with chemical protectant agents, such as preservatives, fire retardants, insecticides, structural modifying agents or other chemical agents which improve the characteristics of the wood or extend its useful life, is well known. As will be recognised however, many of the chemical protectant agents used for the treatment of wood are relatively toxic substances. In particular, many wood preservatives include appreciable levels of heavy metals such as CCA preservatives (copper, chromium and arsenic compounds), CCB preservatives (copper, chromium and borine compounds), and ammoniacal or amine copper based preservative systems. It is therefore desirable that the chemical protectant agent should be confined within the treated wood such that leaching of the toxic chemicals into the environment is prevented or reduced to negligible levels.

Many of the protectant compounds applied to wood by well known impregnation procedures will undergo true fixing reactions within the wood to form water insoluble or largely insoluble compounds bound to wood constituents. Once this fixation process has taken place it will be largely impossible for treatment chemical to leach from the treated wood, so that any negative environmental impact is greatly reduced or virtually eliminated. Often, the rate of fixation of chemical protectants within the wood is increased with increased temperature. In other cases, although the chemical protectant does not in fact undergo a true chemical fixation, subsequent leaching of the protectant agent can be reduced by ensuring that excess treatment agent is removed from the treated wood, during the overall treatment process.

Heat fixation of wood has been most commonly conducted by the use of steam, where the steam is injected into a chamber containing packs of the treated wood product. These packs are usually stacked with spacers, to encourage ingress of steam within the pack. This approach is however problematic, as not only does it result in condensate contaminated with chemicals on and from the wood, but it is inherently difficult to effect uniform temperature conditions in a large scale plant. Deterioration of wood quality will occur wherever temperature is not adequately controlled. In particular, liquefaction and movement of resin in the wood will occur above a characteristic temperature, dependent on resource characteristics and processing history. In general, for most wood types this temperature is between about 80° C. and about 100° C. For example the characteristic temperature for kiln dried pine is about 80° C. to 90° C. The formation of surface resin deposits can be unsightly, and will generally reduce the value of the wood product.

U.S. Pat. No. 4,927,672 to Drinkard outlines a process for accelerated fixing of heat fixable wood preservatives in wood, essentially by immersion of the wood within water that is heated to at least 100° F. Again, problems are associated with this process as a large amount of water is involved. This water becomes a toxic waste material because of the levels of wood preservative agents with which it becomes contaminated. A particular problem is the formation of insoluble precipitates as a result of heating of the process water which is contaminated with chemical protectants and wood extractives. This can adversely effect the appearance of the wood as a result of surface deposits of the insoluble products upon the wood surfaces.

An improvement upon the Drinkard process has been proposed by Bergervoet el al in U.S. patent application Ser. No. 08/609,087, wherein wood is immersed in an aqueous liquid heating medium that is heated to at least 150° F. and various means are used to control contamination of the process water. One such means is the use of filters to remove the solid reaction products formed from the contamination. This process also advocates the use of pressure and vacuum during the process to contain the contamination. Once again however, a number of problems are associated with this process, namely that as a result of filtration of the liquid heating medium, a waste stream of treatment chemicals is generated which may constitute a toxic waste which must be disposed of. Secondly, given the necessity to apply a vacuum, the whole process must be effected within a pressure vessel, thereby contributing to capital, maintenance and operating costs of the process.

Accordingly, it is a object of the present invention to provide a process for fixation of wood which has been treated with protective agents, wherein such process does not involve the formation to any substantial extent of environmentally harmful biproducts, and wherein the process can be effected with a plant requiring relatively low capital, maintenance and operating costs.

It is a further object of the invention to overcome, or at least substantially ameliorate the problems associated with wood fixation processes known to date.

### SUMMARY OF THE INVENTION

According to one embodiment of the present invention there is provided a fixation process for chemically treated wood comprising the following steps:

(a) Transferring a charge of wood which has been treated with one or more chemical protectants into a fixation vessel;

(b) Applying a treatment volume of water to the wood within the fixation vessel in batches or a continuous stream such that the wood is not submerged in water:

(c) Collecting the water after application to the wood so that this water can be used to prepare protectant impregnation solution for protectant treatment of subsequent wood charges;

(d) Removing the charge of wood which has been subjected to the fixation process from the fixation vessel.

According to another embodiment of the present invention there is provided a fixation process as referred to above wherein the water applied at step (b) is heated to between about 40° C. and about 80° C.

According to another embodiment of the present invention there is provided a fixation process as referred to above wherein the treatment volume of water applied at step (b) is between about 10% and about 150% of the volume of protectant impregnation solution expected to be absorbed by the charge of wood during chemical protectant treatment.

According to a further embodiment of the present invention there is provided a fixation process as referred to above wherein the water applied to the wood at step (b) is applied in a continuous stream over a period of between about 20 minutes and about 3 hours.

According to a still further embodiment of the present invention there is provided a fixation process as referred to above wherein the water applied to the wood at step (b) is applied in a plurality of batches that are collected and reapplied to the wood so that the cumulative sum of batch volumes approximates the treatment volume.

According to a still further embodiment of the present invention there is provided a fixation process as referred to above which comprises the further step following either step (b) or step (c) of:

(e) retaining a charge of wood within the fixation vessel for a period of time in order to allow excess water to drain and/or evaporate from the wood.

According to an even further aspect of the present invention there is provided a fixation process as referred to above with the further step after step (d) of:

(f) placing the charge of wood in weather-protected storage for a period of time.

### DETAILED DESCRIPTION OF THE INVENTION

Throughout the specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

As outlined above the present invention relates to a fixation process for chemically treated wood. It should be understood that throughout the specification and the appended claims the term “fixation process” is intended to include within its scope both true fixation wherein chemical protectant agents are bound to wood components during the fixation process as well as processes which involve the leaching and/or washing of excess treatment chemicals from the treated wood in order that such chemicals cannot subsequently be released into the environment.

It is therefore envisaged that the process according to the present invention can be usefully employed after wood has been treated with a broad range of chemicals for a similarly broad range of purposes. For example the protectant chemicals involved may be preservative agents such as for example CCA, CCB or boron, ammoniacal or amine copper type wood preservatives, colouring agents, resins, fire retardants, fungicides, insecticides, water-proofing agents, anti-static agents, dimensional stabilisers, anti-checking agents, wood softening agents or any other chemical agents with which wood may usefully be treated and in relation to which the fixing process of the present invention can usefully be employed. In a preferred embodiment of the invention the fixation process is a heat fixation process such that the water used in the process is heated to increase the rate of true fixation which takes place following treatment of the wood with a heat fixing chemical.

In order to carry out the process wood is transferred into a fixation vessel following its treatment with one or more chemical protectants. Ideally, the transfer of the wood into the fixation vessel will take place directly after the treatment with chemical protectant has been completed. It is however possible to delay the transfer of the wood into the fixation vessel, although it is likely that a number of the advantages of the present process will be minimised by so doing. For example, it is possible to allow the wood to stand for sometime either within the vessel that the wood has been chemically treated or within the fixation vessel prior the commencement of the fixation process. Alternatively, it is possible to transfer the treated, unfixed wood to a storage location for a period of time prior to commencement of the fixation process. The problems associated with these alternatives are that product flow is interrupted, expensive stock must be held for longer, and protectant impregnation solution which has been applied to the wood in the treatment process would drip and/or leach from the treated wood while it is being stored. Therefore, if it is proposed that the wood should be stored after the protectant treatment and prior to the fixation process, it is desirable, although not essential, that any excess protected impregnation solution which drips or leaches from the treated wood should be collected in order that it can be recycled as is proposed in the fixation process itself. As outlined above however, it is desirable that the treated unfixed wood should be transferred directly into a fixation vessel, following cessation of the treatment process.

The wood which has been treated and is transferred into the fixation vessel will, for the purposes of this specification and the appended claims, be referred to as “a charge of wood”. The wood itself may be derived from any tree species, obviously depending upon the use to which it is to be put and the protective treatment which is being carried out. Specific, non-limiting examples of wood which may be used in the process are timber derived from species of pine, eucalypt, mountain ash, oak.

The wood treated in the process may vary from being raw timber to wood that has been refined (fine sawn boards). The charge of wood may comprise packs of tightly stacked pieces, or layers separated by the use of spacers, as is well known in the art. Naturally, it is preferable for drying the wood before chemical protectant treatment that the wood is separated by spacers as in this arrangement the rate and extent of drying into the wood packs is greatest. Similarly, it will improve ingress of the fixation medium, and egress of moisture during drying after fixation.

The fixation vessel utilised in the process of the invention can take many different forms. It will however comprise an enclosed space which is equipped with some form of support for charges of wood being treated, and a drainage system which will allow collection of water after application to the wood in order that the water can be recycled. Naturally the fixation vessel will also be provided with nozzles or outlets for the water to be applied to the wood in either batches or a continuous stream, preferably in a spray. Preferably there will also be some kind of conveyance or crane system for the easy transport of charges of wood from the section of the plant where chemical protectant treatment takes place into the fixation vessel, and then again out from the fixation vessel.

In another preferred embodiment of the invention the fixation vessel will be designed such that it will allow the simultaneous application of water to one charge of wood while another charge of wood is allowed to drain and/or to allow excess water to evaporate, for a period of time. In this way any water which either drips or leaches from the treated wood can be collected by the recycling collection system. Preferably therefore, the fixation vessel is a dual-width vessel provided with means to divert fixation water to either charge within said vessel.

In the most preferred embodiment of the invention a charge of wood will pass from the area of the plant where it has undergone chemical protectant treatment to an area of the plant where it will then undergo the fixation process of the invention. The minimum requirement for this fixation area is a fixation vessel or chamber and the equipment needed to effect the fixation process. A facility for weather protected storage of treated wood is optional. For the preferred dual- or multiple-width fixation vessel, upon completion of water application to a charge, said charge can be retained in the vessel to drain while water is applied to another charge. When the fixation process for a charge is complete, it will be removed from the fixation vessel and its place will be taken by the next charge of wood from the chemical protectant treatment area or fixation treatment.

As referred to above, it is preferred that after being removed from the fixation vessel, treated charges of wood will be stored in a weather-protected storage area for a period of time in order that any excess water and/or protectant impregnation solution can be drained from the wood, and collected by the recycling system, prior to transfer of the charge of wood to normal storage to await consignment.

If the water is applied to the charge of wood during the fixation process in a continuous stream, this water will simply be collected and will then be used in the preparation of the protectant impregnation solution for the protectant treatment of subsequent wood charges. As an example of the continuous stream approach, the continuous stream may be applied for between about 2 mins and about 3 hours. Preferably for a period of about 90 mins, although the main criterion upon the time period is that the fixation vessel is available to receive the next protectant treated charge once protectant treatment is complete. In the situation where batch volumes of water are applied to the wood, then each batch of water will be collected and preferably continuously transferred to a storage tank from which it is re-applied to the wood during the fixation process. For example, it is envisaged that if for a given amount of wood a 2000 liter volume of water is to be applied, this may for example be applied as five 400 liter volumes of water which are applied as five successive batches. If these were to be applied over a total of 90 minutes, each batch would be recirculated for approximately 18 minutes. This however, is mentioned by way of example only and is not intended to be limiting upon the scope of protection sought.

The exact nature of water application for the process, for example the volume of each successive batch and the extent to which it is recirculated, depends on the total volume of water available for the process, the amount of wood being treated, the nature and quantity of the chemical protectant that was applied to the wood, the type of wood, and the environmental performance requirements for the process.

In many instances it will be appropriate for the treatment water to be heated, especially in the case where the chemical protectant which has been applied to the wood earlier is a heat fixing chemical protectant. In such instances it is appropriate to heat the treatment water to between about 20° C. and 100° C., preferably to between about 50° C. and 80° C. before it is applied to the wood. In the case where the treatment water is heated, the fixation vessel will ideally be heat insulated in order to prevent the loss of heat and thereby improve performance and reduce operational costs. A heat exchanger may also be suitably employed in order that collected treatment water can be used to heat water which will be applied to subsequent wood charges during the fixation process. This heat exchange part of the process will have the benefit of not only reducing the costs associated with heating the water but also reducing the amount of insoluble reaction products formed, due to the water being cooled after the fixation process. There is of course, an interesting dichotomy in relation to the heating as while it is hoped that insoluble reaction products from the chemical protectant treatment will be formed within the wood itself, due to heating, this is certainly not desired within the water as any insoluble reaction products will become an undesired waste product. The intention therefore is to raise the temperature of the wood using heated water, for an extended period of time in order for the heat fixation to take place. The water used to heat the wood however, is only at elevated temperature for a fraction of that time. During the fixation process, discharged water is cooled, preferably by heat exchange with incoming water, to conserve heat energy by the fixation process, to prevent the heat formation of insoluble reaction products in the discharged water, and to permit immediate utilisation of the discharged water, for example in preparation of protectant impregnation solution which will be applied to subsequent wood charges. By utilising this process not only is wood protectant chemical conserved, such that the plant is more economical to run, but also formation of environmentally hazardous by-products is minimised.

Another aspect of the present invention is the fact that by utilising the inventive process the amount of water needed for fixation can be minimised. Although the process can successfully be effected using either very large or very small volumes of water, naturally the performance of the process will be affected by the volume used.

As the volume of water available for the process is reduced, the number of batches or batch volumes must also be less per unit volume of wood. In either case, in order to maintain a desired flow rate and duration of application, the water must be retained for longer. The main disadvantage of this is that there will be less benefit from the washing effect, and subjecting the process water to elevated temperature for longer increases the risk of forming insoluble reaction products.

In general terms however, it is preferred that the treatment volume of water utilised in the fixation process will be between about 10% and about 200% of the volume of protectant impregnation solution that is expected to be absorbed by the charge of wood during its chemical protectant treatment. By this, what is meant is not that for each charge of wood which is to undergo the fixation process a detailed calculation will be undertaken to determine the amount of protected impregnation solution absorbed during the chemical protectant treatment. Rather, from experience with particular types and volumes of wood and the knowledge of their absorbance with respect to the nature of the chemical solution used in the treatment process, persons skilled in the art will readily determine the amount of protectant impregnation solution which is expected to be absorbed by the charge of wood during the chemical protectant treatment. It will be readily recognised by a person skilled in the art that there is a good deal of tolerance in relation to the treatment volume of water applied to the wood in the fixation process which will acheive the best results both from an economic and environmental perspective.

In embodiments of the invention wherein the volume of water utilized in the fixation process is in excess of 100% of the volume of protectant impregnation solution that is expected to be absorbed by the charge of wood during its chemical protectant treatment, it will not be possible to utilize all the fixation water in the chemical protectant treatment of subsequent charges of wood. In this case it will be necessary to treat the excess water to remove contaminants. This can be done by techniques well known in the art.

In an especially prefered embodiment of the invention the treatment volume of water applied during the fixation process is between about 50% and about 100% of the volume of protectant impregnation solution expected to be absorbed by the charge of wood during chemical preservative treatment. In the most preferred embodiment of the invention the treatment volume of water applied during the fixation process will be about the same as the volume of protectant impregnation solution expected to be absorbed by the charge of wood during chemical preservative treatment. As emphasised above however, there is a good deal of tolerance in relation to the treatment volume of water depending upon specific circumstances associated with the treatment such as wood type, volume, the nature of chemical treatment and the use to which the wood is ultimately to be put.

The invention will now be further described with reference to the following non-limiting examples.

### EXAMPLES

### EXAMPLE 1

Fixation of chemically treated radiata pine with continuous stream process.

The sapwood of dry or seasoned radiata pine will typically absorb up to about 600 liters/m³ of preservative solution. Charge absorbtions are usually less however, due to the presence of some heartwood which is not readily penetrated, as well as due to the use of treatment processes which partially fill voids within the wood. This example is based upon a treatment plant with the capacity to treat 10 cubic meters of wood per charge, a target production cycle time of 90 minutes and a typical treatment absorbtion of 400 liters/m³ per charge. As will be recognised, production capacity and resource behaviour will vary considerably, and the values referred to above provide the basis for this example only.

Given that a 10 m³ charge of wood typically absorbs 400/m of protectant impregnation solution, it would be most desirable to apply between about 400 liters to about 8000 liters to each charge of wood during the fixation process. It is preferable that between about 2000 liters and about 4000 liters should be available, and most preferable that around 4000 liters should be used.

Application of 4000 liters of water to 10 m³ of treated wood as a continuous stream in a single pass over 90 minutes equates to a rate of approximately 4.4l/m³ min.

Once the wood is transferred into the fixation vessel the water is applied to the wood charge by means of water outlets, such as for example sprays or jets, at the required flow rate. As water drains to the base of the fixation vessel it is collected so that it can be transferred to a reservoir water tank and subsequently used to prepare protectant impregnation solution for protectant treatment of subsequent charges of wood.

### EXAMPLE 2

Fixation treatment of radiata pine by batch treatment fixation process.

As in example 1 a 10 m³ charge of radiata pine was used in the fixation process, and was expected to absorb approximately 400l/m³ of protectant impregnation solution during the chemical protectant treatment. By employing the preferred means of application of the water, namely as a series of batches, higher flow rates over the nominated process time can be achieved. The steps of the process are as follows:

1. The treated wood is transferred to a chamber for effecting the process. Primary functions of the chamber are to support the system for distributing water onto the wood, to contain and collect this water, and to direct it to a drainage point. Thermal insulation of the chamber is advisable where the process uses heat.

2. A purpose-built tank is charged with the first batch, e.g. 800 l, of water. The tank is fitted with liquid level detection and heating equipment as required to effect filling and temperature control.

3. Water is pumped from the tank over the wood via distribution means at a rate which provides adequate coverage of the wood, and percolation and penetration of the water into the wood charge. The suggested minimum flow rate is 10 mm per minute effective water depth over the surface of the pack receiving water at that time, eg 100 liters per minute for a 10 m³ charge of wood.

4. When sufficient volume of water collects at the drainage point in the process chamber, this water is returned to the purpose-built tank in 2 above.

5. The batch is circulated by effecting 3 and 4 above simultaneously for a nominated period of time, e.g. 18 minutes.

6. The spent process water is directed to the treatment system. Generally, this will be to a reservoir water tank used to prepare protectant impregnation solution. Where heat is used in the invention, energy from the spent process water can and should be recovered by passing the water through a heat exchanger, transferring heat energy to fresh process water to be used for the next batch. If two purpose-built tanks or “batch tanks” as in 2 are provided, this will greatly streamline the exchange process. One tank will be receiving fresh water (preheated by heat exchange) while spent process water in the other tank and distribution and collection circuit is being transferred to the treatment system.

7. Once the transfer in 6 above is complete and the next batch of fresh water is ready, the new batch of water is circulated as in 3, 4, and 5 above. If two or more batch tanks are employed, the distribution and collection circuits will alternate between said tanks for each successive batch. A wait period between application of batches may be beneficial.

8. The actions described in steps 3 to 7 above are repeated until the nominated total volume of water (treatment volume) has been applied. For example, a total of five batches each of 800 l would apply the target total of 4000 l. Note that the volume and duration of application of each batch need not be equal.

9. Preferably, the wood is retained in the chamber for a time which will permit additional fixation and moisture loss (drippage and evaporative drying) to occur. A dual-width process chamber would permit this period to be up to one protectant impregnation cycle in duration.

10. The wood is removed from the process chamber, where it may be moved to weather-protected storage to take further advantage of the conditioning imparted by the process.

It is to be understood that the present invention has been described by way of example only and that modifications and/or alterations to the process described herein, which would be obvious to a person skilled in the art on the basis of this specification, are also considered to fall within the scope and spirit of the invention as defined herein with reference to the appended claims.

The claims defining the invention are as follows:

1. A fixation process for chemically treated wood comprising the following steps:
(a) Transferring a charge of wood which has been treated with one or more chemical protectants into a fixation vessel;
(b) Applying a treatment volume of water to the wood within the fixation vessel in batches or a continuous stream such that the wood is not submerged in water;
(c) Collecting the water after application to the wood so that this water can be used to prepare a protectant impregnation solution for protectant treatment of subsequent wood charges;
(d) Removing the charge of wood which has been subjected to the fixation process from the fixation vessel.

2. The fixation process as claimed in claim 1 wherein the water applied at step (b) is heated to between about 20° C. and about 100° C.

3. The fixation process as claimed in claim 2 wherein the water applied at step (b) is heated to between about 50° C. and about 80° C.

4. The fixation process as claimed in either claim 2 or claim 3 wherein the wood has been treated with a heat fixing chemical protectant.

5. The fixation process of any one of claims 2 to 4 wherein a heat exchanger is employed in order that heat from water collected at step (c) can be transferred to water to be used in step (b) of the fixation process of subsequent wood charges.

6. The fixation process as claimed in any one of claims 2 to 5 wherein the fixation vessel is heat insulated.

7. The fixation process as claimed in any one of claims 1 to 6 wherein the treatment volume of water applied at step (b) is between about 10% and about 200% of the volume of protectant impregnation solution expected to be absorbed by the charge of wood during chemical protectant treatment.

8. The fixation process according to claim 7 wherein the treatment volume of water applied at step (b) is between about 50% and about 100% of the volume of protectant impregnation solution expected to be absorbed by the charge of wood during chemical protectant treatment.

9. The fixation process as claimed in claim 8 wherein the treatment volume of water applied at step (b) is about the same as the volume of protectant impregnation solution expected to be absorbed by the charge of wood during chemical preservative treatment.

10. The fixation process as claimed in any one of claims 7 to 9 wherein discharge water not used for preparation of chemical protectant solution is treated to remove contaminants.

11. The fixation process as claimed in any one of claims 1 to 10 wherein the water applied to the wood at step (b) is applied in a continuous stream.

12. The fixation process as claimed in any one of claims 1 to 10 wherein the water applied to the wood at step (b) is applied in a series of batches.

13. The fixation process as claimed in any one of claims 1 to 9 wherein the water applied to the wood at step (b) is applied in a plurality of batches that are collected and reapplied to the wood in sequence so that the cumulative sum of batch volumes approximates the treatment volume.

14. The fixation process as claimed in any one of claims 1 to 13 which comprises the further step following either step (b) or step (c) of:
(e) Retaining a charge of wood within the fixation vessel for a period of time.

15. The fixation process as claimed in claim 14 wherein the total duration of steps (a) to (e) approximates the duration of chemical protectant treatment.

16. The fixation process as claimed in claim 14 wherein steps (a) to (e) are carried out simultaneously with multiple charges of wood within the fixation vessel.

17. The fixation process as claimed in claim 16 wherein the total duration of steps (a) to (e) approximates the product of the number of charges held by the fixation vessel and the duration of the chemical protectant treatment.

18. The fixation process as claimed in any one of claims 1 to 17 with the further step after step (d) of:
(f) Placing the charge of wood in weather-protected storage for a period of time.
